(19) United States
(12) Patent Application Publication
(10) Pub. No.: US 2011/0121987 A1
(43) Pub. Date: May 26, 2011

(54) Ice Rink Door Safety System

(76) Inventor: Thomas Raymond McDonnell, Evanston, IL (US)

(21) Appl. No.: 12/625,426

(22) Filed: Nov. 24, 2009

(51) Int. Cl. G08B 21/00; F21V 23/04; H01H 35/00

(52) U.S. Cl. 340/686.6; 362/276; 200/52 R

(57) ABSTRACT

A warning system comprising a proximity switch, fluorescent light and power source (AC or DC) which illuminates when the door of an ice rink is not fully closed and latched. The proximity switch, light and power source are all connected and installed on the inside of the ice rink boards, adjacent to the latch on the ice rink board's door. When the door latch on the ice rink boards is fully closed, the proximity switch shuts off power to the light which then turns off the light indicating the door is closed. If the door latch is not fully closed, the proximity switch is not flipped and power goes to the light indicating that the door is open. The ensuing benefit includes the reduction of injuries as a result of the warning light indicating the door to the ice rink is in fact open, which may result in a person inadvertently being injured as a result.

### TECHNICAL FIELD

This invention relates to a safety light for providing a notification that the various ice rink doors are not fully latched and therefore provide an opportunity for a person to be injured on the ice rink. More particularly, this invention relates to a proximity switch, fluorescent light and power source attached to the boards of an ice rink near each ice rink door.

### BACKGROUND OF THE INVENTION

Ice rink dasher board systems provide an outer wall surface for a hockey rink and include lower dasher board sections, plexi-glass upper shielding and doors to enter or exit the ice rink. There are typically 6-12 doors to any ice rink depending on the specific layout of the facility. The doors allow various parties access to the ice rink including hockey players, figure skaters, referees, coaches and zamboni operators. During any event on the ice rink, doors are opened and closed several times to allow skaters access to the ice rink. One example includes hockey players exiting and entering the hockey bench during the progression of a normal hockey game. In addition, penalty box and zamboni operating doors are used several times a game. Given the size of the ice rink dasher boards, the doors to the ice rink are rather heavy and very clumsy in closing. As a result, the door latches can be very challenging to open and close. For the most part, players and skaters of the specific event (e.g. hockey game) are required to act as a “doorman” opening and closing the doors throughout the game. There is no specific training offered to the skaters to open and close the doors. Further complicating the matter, there is no standardization to the various doors and door latches which makes each experience at a new ice rink very challenging to the skater or coach who is required to open and close the given door.

The pace of skaters on an ice rink can be very significant. Skating, according to physicist Thomas Humphrey is “the fastest way to travel on the surface of the earth on your feet.” When you run, your front foot slows you down every time it hits the ground. In skating, one skate pushes and the other skate glides—there is very little friction to slow you down. Speed skater Hiroyasu Shimizu of Japan can travel 500 meters in just 35.39 seconds, an average speed of 14.13 meters per second or 31.6 miles per hour. Many NHL players can reach speeds in excess of 20 miles (32 km) per hour on the ice.

As a result of the difficulty in closing doors and the significant pace of typical skaters, many injuries are sustained from skaters falling or being “checked” into unlatched, open ice rink doors. When the ice rink doors are opened, the dasher boards are exposed to the skater which can be extremely dangerous. The exposed dasher boards have sharp edges which include metal and fiberglass exposures. In a study by Pasqualino Caputo and Douglas J. Mattson, it was revealed that collisions with the ice rink boards accounted for almost 30% of the total injuries in ice hockey. In many cases, injuries from being “checked” into open doors have resulted in significant career ending injuries (e.g. Vincent John Gernat—Buffalo State College). Further safety precautions need to be implemented in hockey in order to avoid serious injuries. The present invention was developed to accomplish the objective of reducing ice rink injuries from open, unlatched doors.

Therefore, a safety light system installed at each ice rink door is needed to ensure that doors are fully closed and latched in order to overcome the problems that arise from open, unlatched doors.

### SUMMARY OF THE INVENTION

The present invention overcomes the above disadvantages by providing a safety light at each ice rink door which is triggered and displays a light when the door latch is not in the closed position. This essentially ensures that the door will be closed and thus prevent injuries to ice rink skaters.

The ice rink door safety light of the present invention includes a proximity switch attached at the point the latch (e.g. guillotine, deadbolt) on the door connects with the side boards ensuring the door will not open if the force of a skater is pushed against it. The proximity switch is in an “off” position when the door is closed, and in an “on” position when the door is open or not fully latched.

Connected to the proximity switch via an electrical wire is a fluorescent light that is mounted in a visible position at the top of the dasher boards. The light is illuminated when the proximity switch is in an “on” position. This indicates that the door is open and the latch is not fully closed. Presumably, this acts as a warning signal so that skaters or coaches have knowledge that the door is in an open position and that there is a potentially dangerous situation at hand. If the door is closed, the proximity switch is “off” and the fluorescent light is off (not illuminated). This indicates that the doors are all safe at that point in time.

Lastly, the present invention includes a power source connected to the proximity switch. This power source enables the fluorescent light to turn on or off depending on the situation at hand. The power source can either be via a battery (direct current) or alternating current (AC) from a source at the ice rink. Regardless of the power source, the proximity switch and fluorescent light need the ability to draw voltage from an outside source that is part of the overall invention mentioned in this writing.

### BRIEF DESCRIPTION OF THE DRAWINGS

The above aspects of the ice rink door safety lights can be seen from the following drawings, in which:

FIG. 1 is an overall perspective view of a typical ice rink with a sample of the various doors that would be impacted by the present invention;

FIG. 2 is a more detailed perspective view of one of the doors and the ice rink safety light system implemented on the door shown in FIG. 1;

FIG. 3 is a sample proximity switch shown in FIG. 2;

### DESCRIPTIONS OF THE PREFERRED EMBODIMENTS

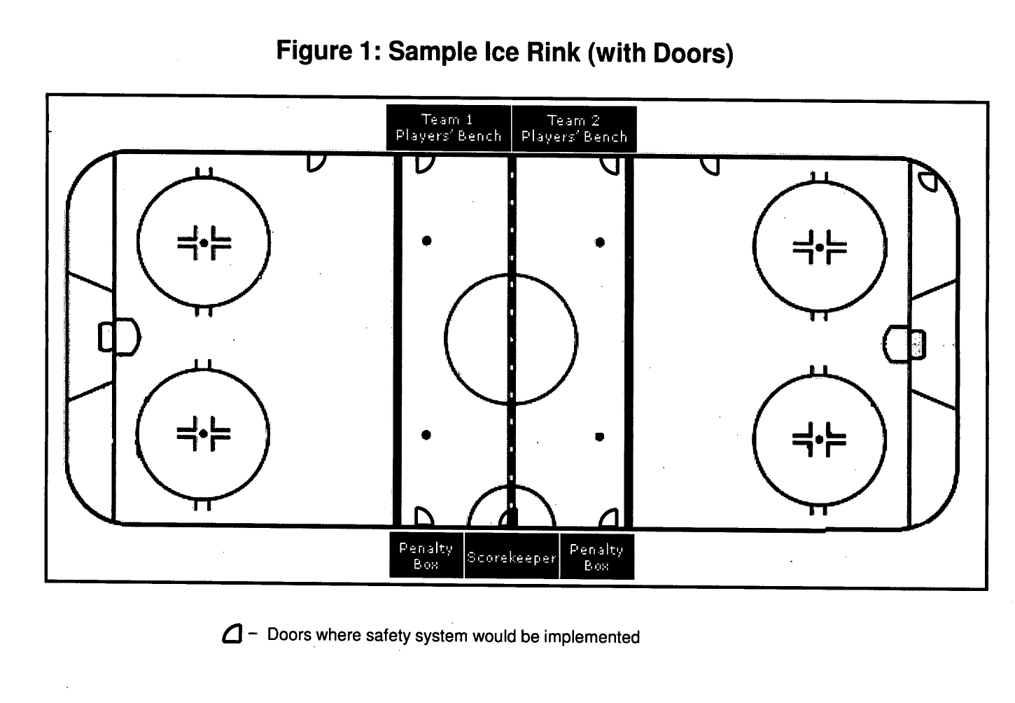

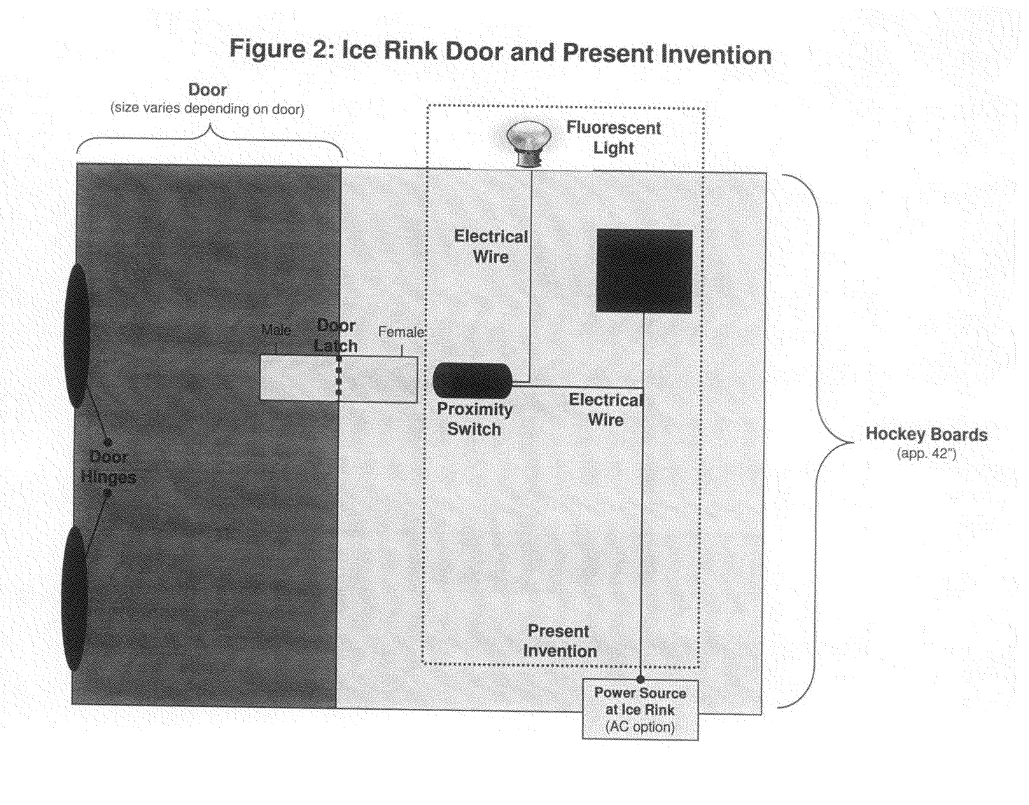

The various ice rink doors to be impacted by the described invention are illustrated in FIG. 1. Each door will be custom fit with a safety light system shown in FIG. 2 (e.g. Present Invention). Given the variety of ice rinks in the marketplace, the exact number of doors to be custom fit with the proposed safety system will vary. The present invention is intended to be installed on each door at the ice rink to ensure adequate safety of the skaters, coaches or other participants needing access to the rink through the doors.

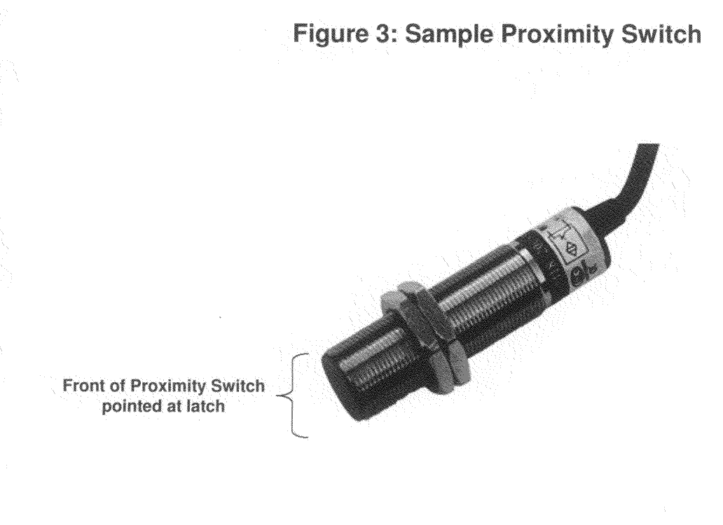

The proximity switch in FIG. 3 will be mounted in a position to the door latch so that when the door latch is fully engaged, the proximity switch will be triggered, and power will be shut off to the fluorescent light. The placement of the proximity switch is a pivotal component to the overall safety light system. The proximity switch will be fully secured to the inside of the dasher boards through a series of screws in order to ensure the switch is fully secure. Given the variety of dash board systems and door latches used, a standardized mounting display is impractical. Each mount will be dependent on the given configuration of the said dasher boards and doors at the ice rink.

The proximity switch will be connected to a fluorescent light by an electrical wire (and conduit) per FIG. 2. The fluorescent light will be mounted at the top of the dasher boards in a visible spot so that all attendees will be alerted when the door is not fully latched. The exact placement of the fluorescent light will be customized dependent on the specific dimensions of the given ice rink door that is being mounted with the safety device.

The final component of the safety system includes a power source for the fluorescent light. The power source can be provided by a battery (direct current) or through an AC power source at the ice rink. Regardless of the power source, the present invention with a proximity switch and fluorescent light will work in a similar fashion. The power source and fluorescent light will be attached via separate electrical wires to the proximity switch according to the specific wiring guidelines of the given proximity switch.

This description is for illustrative purposes only. Modification can be made, particularly with regard to matters of shape, size and arrangement of parts, within the scope of the invention as defined by the claims.

What is claimed is:

1. A proximity switch attached to the boards of an ice rink near each door and corresponding door latch

2. A proximity switch as in claim 1, with two electrical current wires attached

3. A fluorescent light attached to the proximity switch as in claim 2 by an electrical wire

4. A power source attached to the proximity switch as in claim 2 by an electrical wire. The power source can be either (a) a battery providing direct current (DC) to the fluorescent light or (b) an alternating current (AC) with power provided at the said ice rink

5. A method of securing the ice rink board safety light components to an ice rink board in order to successfully implement the ice rink board light. The method comprising the steps of: (a) placing a proximity switch near the female end of the door latch at a distance that indicates that the ice rink door is fully closed and latched, (b) attaching an electrical wire with one end on the proximity switch and the other end connected to a fluorescent light that is attached to the top of the ice rink boards and is visible as an indication whether the latch is fully closed or not, (c) attaching the proximity switch to a power source that can either be alternating current (AC) or direct current (DC).

6. The method as recited in claim 5, further comprising the step of customizing the implementation to the given ice rink boards given the wide variety of boards and latches potentially available for installation.
